(19) United States
(12) Patent Application Publication
(10) Pub. No.: US 2005/0270649 A1
(43) Pub. Date: Dec. 8, 2005

(54) Control circuit, in particular for dimming an EC mirror glass of a rearview mirror of a motor vehicle

(75) Inventors: Rolf Thiel, Stuttgart (DE); Manfred Herrler, Schwabach (DE)

Correspondence Address: WARN, HOFFMANN, MILLER & LALONE, .P.C, PO BOX 70098, ROCHESTER HILLS, MI, 48307, US

(73) Assignee: Schefenacker Vision Systems Germany GmbH, Esslingen (DE)

(21) Appl. No.: 11/144,457

(22) Filed: Jun. 3, 2005

(30) Foreign Application Priority Data
Jun. 5, 2004 (DE) 102004027611.0

(51) Int. Cl. G02B 27/00; G02B 5/08; G02B 17/00

(52) U.S. Cl. 359/603; 359/601

(57) ABSTRACT

A control circuit having particular application in dimming an EC (Electrochromic) mirror glass of a rearview mirror of a motor vehicle. Light flux from headlight glare of vehicles traveling behind is received by one conductor and filtered whereas light flux from the ambient light is received by a second conductor and filtered in a way that complements the first filtering. This allows a single sensor to be used to sense both the ambient light and the glare light which enables simpler control of the dimming function.

### CROSS-REFERENCE TO RELATED APPLICATIONS

This application claims priority to German Patent Application No. 10 2004 027 611.0 filed on Jun. 5, 2004.

### BACKGROUND OF THE INVENTION

The invention relates to a control circuit, in particular for dimming an EC mirror glass of a rearview mirror of a motor vehicle. In more particularity, the invention relates to a circuit comprising a sensor which produces a signal as a function of supplied luminous fluxes.

Control circuits for interior rearview mirrors of motor vehicles are known, wherein the mirror housing is provided with two sensors, one sensor of which detects the glare coming from the vehicle travelling behind and the other sensor detects the ambient light. The two sensors require complex control in order to dim the EC (Electrochromic) mirror glass depending on the intensity of the glare as a function of the ambient light.

An underlying aim of the invention is to develop the generic control circuit in such a way that simple and reliable function is ensured.

### SUMMARY OF INVENTION

This aim is addressed by the invention with a control circuit of the generic type in which the control circuit has at least one light conductor whose light receiving side is preceded by a colour filter and which is arranged to supply filtered luminous flux to the sensor, which is a colour sensor.

As a result of the arrangement according to the invention, a portion of the luminous flux is blocked on its passage through the colour filter. The luminous flux filtered in this way is supplied to the sensor by the light conductor. With the light conductor the light can be reliably supplied to the sensor, which converts the filtered luminous flux into an electrical signal.

Advantageously, at least two luminous fluxes from at least two light sources are supplied by means of one light conductor in each case to the colour sensor. Both light conductors which are tuned to various wavelengths are preceded in each case by a colour filter.

Advantageously, the control circuit according to the invention is used to manipulate the EC mirror glass of vehicle rearview mirrors. Here, the luminous flux coming from the glare of a vehicle travelling behind as well as the luminous flux coming from ambient light after being filtered by the light conductors is supplied to the colour sensor. This evaluates the light signals and produces a signal, in order to dim the EC mirror glass as soon as the luminous value drops below a critical parameter.

Since only one sensor is provided, the technical complexity of the control circuit can be kept to a minimum.

The rearview mirror can be an interior and/or an external rearview mirror of a motor vehicle. Further components such as a heater for the mirror glass, an antenna, loudspeaker, means of illumination for reading and/or interior lighting, a compass, a display device, a flashing light, parts of a garage door opener, a GPS module and the like can be provided in or on the housing of these rearview mirrors. These components can be arranged in any arbitrary combination. As further applications monitoring systems, which monitor various light sources instead of measuring the operating voltage or operating current, can be provided.

Other features of the invention are evident from the further claims, description and drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention is described in detail, by way of non-limitative example only, with reference to an embodiment illustrated in the drawings, in which:

FIG. 1 is an illustration of a rearview mirror of a vehicle with a sensor,

FIG. 2 is a schematic illustration of a control circuit according to the invention of the rearview mirror in FIG. 1; and

FIG. 3 is an enlarged and exploded view of the sensor in FIG. 1.

### DETAILED DESCRIPTION OF THE PREFERRED EMBODIMENTS

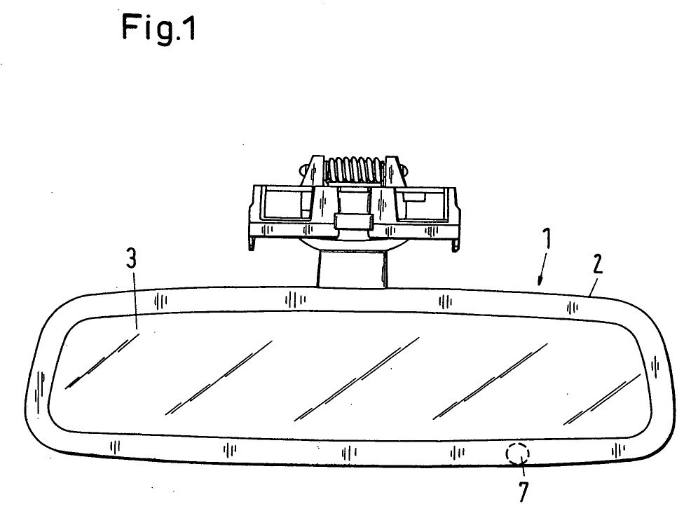

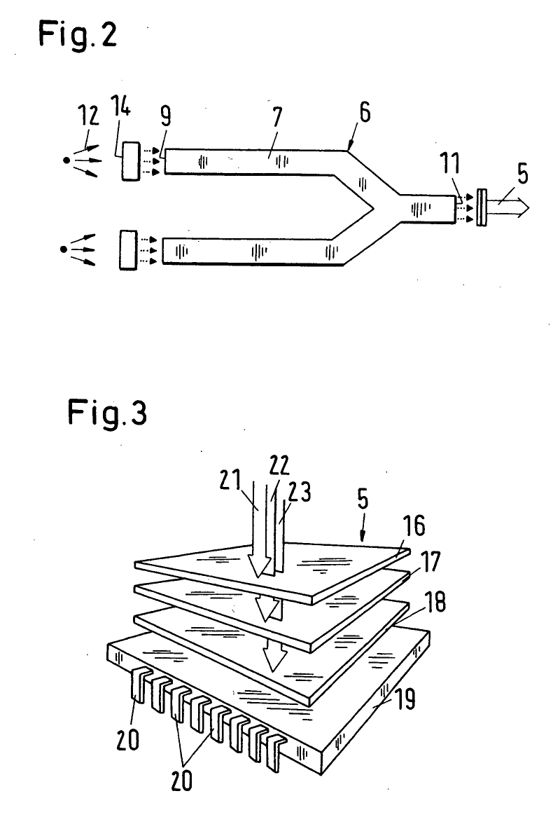

FIG. 1 shows an interior rearview mirror 1 of a motor vehicle, which has a housing 2 with a housing opening for an EC mirror glass 3. In order to prevent the driver being dazzled by the light from a vehicle travelling behind falling on the mirror glass 3, a sensor 5 (not shown in FIG. 1) is incorporated in the frame 4 surrounding the EC mirror glass 3. On detecting glare this sends a control signal, whereby the mirror glass 3 is dimmed in the known way, so that the driver is not dazzled. The sensor 5 can of course also be incorporated at any random place in the mirror housing or in the vehicle interior.

The sensor 5 is a colour sensor, which converts the luminous flux supplied thereto into an electrical signal, which is used to control the EC mirror glass 3. The sensor 5 is part of a control circuit 6, comprising two light conductors 7, 8, which in the region before the sensor 5 merge into one another. Light conductor 7 is shown in FIG. 1.

A light radiating face 11 of the merged light conductors 7, 8 lies opposite the sensor 5. The light conductors 7, 8 are arranged so that their light receiving face 9, 10 is directed to the rear and to the front in the driving direction of the vehicle. The glare 12 of the vehicle travelling behind falls onto the receiving face 9 directed to the rear, while the receiving face 10 directed to the front detects the ambient light 13. The light is supplied to the sensor 5 by both light conductors 7, 8. Depending on the intensity of the luminous flux the mirror glass 3 is dimmed to a greater or lesser extent.

So that the sensor 5 can separate the glare and the ambient light 12, 13, in each case colour filters 14, 15 are arranged in the region before the light receiving face 9 of the light conductor 7 and before the light receiving face 10 of the light conductor 8. They are selected in such a way that they allow light of a certain wavelength and/or within a certain wavelength range to pass through to the downstream light conductor 7, 8. The various light sources 12, 13 are therefore differentiated by separation of the spectral ranges. For example, the colour filter 14 only allows light of the wavelengths, which mainly correspond to the colour green to pass through. The colour filter 15 is designed for a wavelength range, which just blocks the green portion, having been allowed through by the first colour filter 14, for example.

The sensor 5 subsequently evaluates the luminous fluxes which have been filtered and supplied by the light conductors 7, 8. The values for the colour green in the embodiment are to be assigned to the luminosity of the first light source 12, the values of the other colour portion corresponding to the second light source 13. Naturally, the colour filters 14, 15 can also be arranged differently or translucent and/or blocking as regards other colours.

The working principle of the control circuit 6 therefore consists of superimposing the light from two or more light sources, which is supplied by the light conductors 7, 8 to the photo-sensitive sensor 5. Before the glare 12 and/or the ambient light 13 enters the light conductors 7, 8, it is reduced by the colour filter 14 and/or 15 to the particular spectral portions.

The sensor 5 is a full colour sensor in the form of an X3-CMOS image converter. It has three silicon layers 16 to 18, in which photodiodes sensitized to the primary colours red, green and blue are embedded in each case. Silicon allows light waves to penetrate the material at a varying degree of depth depending on the colour. Thus blue light is completely absorbed nearly on the surface, green light just below and red light far underneath. The result is that each individual pixel of the sensor 5 detects the blue, green and red value for each pixel. The layers 16 to 18 lie on a carrier 19, which is equipped with connector pins 20.

In FIG. 3 blue light is characterised by the arrow 21, green by the arrow 22 and red light by the arrow 23. The blue light 21 is absorbed by the first layer 16 on the surface of the sensor 5, the green light 22 by the middle layer 17 and red light 23 by the lower layer 18. Due to this construction of the sensor 5 the luminous fluxes supplied by the light conductors 7, 8 can be simply and accurately evaluated.

In the embodiment the sensor 5 can assign the values for the colour green to the luminosity of the glare 12 and the values for the other colours to the luminosity of the ambient light 13.

The sensor 5 sends corresponding signals via pins 20 to a control unit, which dims the EC mirror glass 3 to the necessary extent, if a critical luminous value for the glare 12 is exceeded. In the same way the mirror glass 3 lightens again, if the critical luminous value of the glare is not reached. The sensor 5 sends a corresponding signal via the pins 20 to the control unit.

Since the RGB sensor 5 comprises the three layers 16 to 18 corresponding to the primary colours red, green, blue three different light sources, to which one colour filter (red, green, blue) is assigned in each case can be detected.

The colour filters 14, 15 are designed so that overlapping of the wavelengths of the light does not occur. Thus the various light sources 12, 13 can be reliably differentiated from each other.

The colour filters 14, 15 are constructed in the known way. The light conductors 7, 8 are formed so that they catch the light of the respective light source 12, 13, without light of the other light source to be detected falling on the light receiving face 9, 10.

With the arrangements described, the luminosity of the ambient light and glare 13 and/or 12 can be simply determined using only one sensor 5 and thus in a constructively simple way optimum dimming of the mirror glass 3 is achieved.

In place of the RGB sensor 5 described a sensor can also be used, whose pixels are subject to a colour mosaic filter. In this case, the pixels only detect one of the primary colours red, green, blue. The actual colour of the pixel is determined by relating to the adjacent pixels. Also such an RGB sensor can evaluate the supplied luminous fluxes and assign the corresponding luminous values to the light sources 12, 13. If the luminosity of the glare 12 exceeds a critical parameter, the sensor 5 produces a signal for dimming the EC mirror glass 3.

The description of the invention is merely exemplary in nature and, thus, variations that do not depart from the gist of the invention are intended to be within the scope of the invention. Such variations are not to be regarded as a departure from the spirit and scope of the invention.

1. Control circuit for dimming an EC mirror glass of a rearview mirror of a motor vehicle, said control circuit comprising a sensor which produces a signal as a function of supplied luminous fluxes, wherein the control circuit has at least one light conductor, whose light receiving side is preceded by a colour filter and which is arranged to supply a filtered luminous flux to the sensor, which is constructed as a colour sensor.

2. A control circuit according to claim 1, wherein the control circuit has at least one further light conductor, whose light receiving side is preceded by a further colour filter and which is arranged to supply a second filtered luminous flux to the colour sensor.

3. A control circuit, according to claim 2, wherein the colour filters block different wavelengths of light.

4. A control circuit according to claim 1, wherein the colour filters separate the spectral ranges of the luminous flux.

5. A control circuit according to claim 1, wherein there are two light conductors in the region before the colour sensor that are combined into one light conductor.

6. A control circuit according to claim 1, wherein the colour sensor is an RGB sensor.

7. A control circuit according to claim 1, wherein the colour sensor is an X3 CMOS image converter.

8. A mirror for a motor vehicle comprising the control circuit of any one of the preceding claims.

9. A mirror according to claim 8, wherein said at least one light conductor is arranged so that, in use, the received luminous flux is produced by the glare of vehicles travelling behind.

10. A mirror according to claim 8, wherein said further light conductor is arranged so that, in use, the received luminous flux is produced by the ambient light.

11. A mirror according to claim 8, wherein the light receiving side of the light conductors is constructed and/or arranged so that only light of the respective luminous flux enters the respective light conductor.

12. A method of dimming an EC mirror glass, said method comprising:
receiving a first luminous flux;
filtering said first flux;
sensing the colour of said filtered first flux and using the sensed colour to control dimming of the mirror glass.

13. A method according to claim 12, further comprising:
receiving a second luminous flux;
filtering said second flux;
sensing the colour of said filtered second flux and using also this sensed colour to control dimming.

14. A method according to claim 13, wherein said filtered first flux and filtered second flux are sensed by one and the same sensor.

15. A method according to claim 13, wherein said first flux is filtered so as to allow through colour(s) that are blocked when said second flux is filtered.

16. A method according to claim 13, wherein said second flux is ambient light.

17. A method according to claim 12, wherein said first flux is glare from vehicles traveling behind.
